(19) United States
(12) Patent Application Publication
(10) Pub. No.: US 2018/0183857 A1
(43) Pub. Date: Jun. 28, 2018

(54) COLLECTIVE COMMUNICATION OPERATION

(71) Applicant: Intel Corporation, Santa Clara, CA (US)

(72) Inventors: Akhil Langer, Champaign, IL (US); Sayantan Sur, Portland, OR (US)

(73) Assignee: Intel Corporation, Santa Clara, CA (US)

(21) Appl. No.: 15/390,234

(22) Filed: Dec. 23, 2016

(51) Int. Cl. H04L 29/08; H04L 12/24

(52) U.S. Cl. CPC H04L 67/10; H04L 67/42; H04L 41/12

(57) ABSTRACT

Particular embodiments described herein provide for an electronic device that can be configured to consolidate data from one or more processes on a node, where the node is part of a first collection of nodes, communicate the consolidated data to a second node, where the second node is in the first collection of nodes, where the first collection of nodes is part of a first group of a collection of nodes, and communicate the consolidated data to a third node, wherein the third node is in a second collection of nodes, where the second collection of nodes is part of the first group of the collection of nodes. In an example, the node is part of a multi-tiered dragonfly topology network and the data is part of a gather or scatter process.

### TECHNICAL FIELD

This disclosure relates in general to the field of computing, and more particularly, to a collective communication operation.

### BACKGROUND

Interconnected networks are a critical component of some modern computer systems. As processor and memory performance, as well as the number of processors in a multicomputer system, continues to increase, multicomputer interconnected networks are becoming even more critical. One characteristic of an interconnected network is parallel computing. One aspect of parallel computing is the ability to perform collective communication operations. Generally, a collective communication operation can be thought of as a communication operation that involves a group of processes.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system to enable a collective communication operation in accordance with an embodiment of the present disclosure;

FIG. 2 is a simplified block diagram illustrating example details associated with a communication system to enable a collective communication operation in accordance with an embodiment of the present disclosure;

FIG. 3 is a simplified block diagram illustrating example details associated with a communication system to enable a collective communication operation in accordance with an embodiment of the present disclosure;

FIG. 4 is a simplified block diagram illustrating example details associated with a communication system to enable a collective communication operation in accordance with an embodiment of the present disclosure;

FIG. 5A is a simplified block diagram illustrating example details associated with a communication system to enable a collective communication operation in accordance with an embodiment of the present disclosure;

FIG. 5B is a simplified block diagram illustrating example details associated with a communication system to enable a collective communication operation in accordance with an embodiment of the present disclosure;

FIG. 6 is a simplified block diagram illustrating example details associated with a communication system to enable a collective communication operation in accordance with an embodiment of the present disclosure;

FIG. 7A is a simplified block diagram illustrating example details associated with a communication system to enable a collective communication operation in accordance with an embodiment of the present disclosure;

FIG. 7B is a simplified block diagram illustrating example details associated with a communication system to enable a collective communication operation in accordance with an embodiment of the present disclosure;

FIG. 7C is a simplified block diagram illustrating example details associated with a communication system to enable a collective communication operation in accordance with an embodiment of the present disclosure;

FIG. 7D is a simplified block diagram illustrating example details associated with a communication system to enable a collective communication operation in accordance with an embodiment of the present disclosure;

FIG. 7E is a simplified block diagram illustrating example details associated with a communication system to enable a collective communication operation in accordance with an embodiment of the present disclosure;

FIG. 8 is a simplified block diagram illustrating example details associated with a communication system to enable a collective communication operation in accordance with an embodiment of the present disclosure;

FIG. 9 is a simplified flowchart illustrating potential operations that may be associated with the communication system in accordance with an embodiment; and

FIG. 10 is a simplified flowchart illustrating potential operations that may be associated with the communication system in accordance with an embodiment.

The FIGURES of the drawings are not necessarily drawn to scale, as their dimensions can be varied considerably without departing from the scope of the present disclosure.

### DETAILED DESCRIPTION

The following detailed description sets forth example embodiments of apparatuses, methods, and systems relating to a communication system for enabling a collective communication operation. Features such as structure(s), function(s), and/or characteristic(s), for example, are described with reference to one embodiment as a matter of convenience; various embodiments may be implemented with any suitable one or more of the described features.

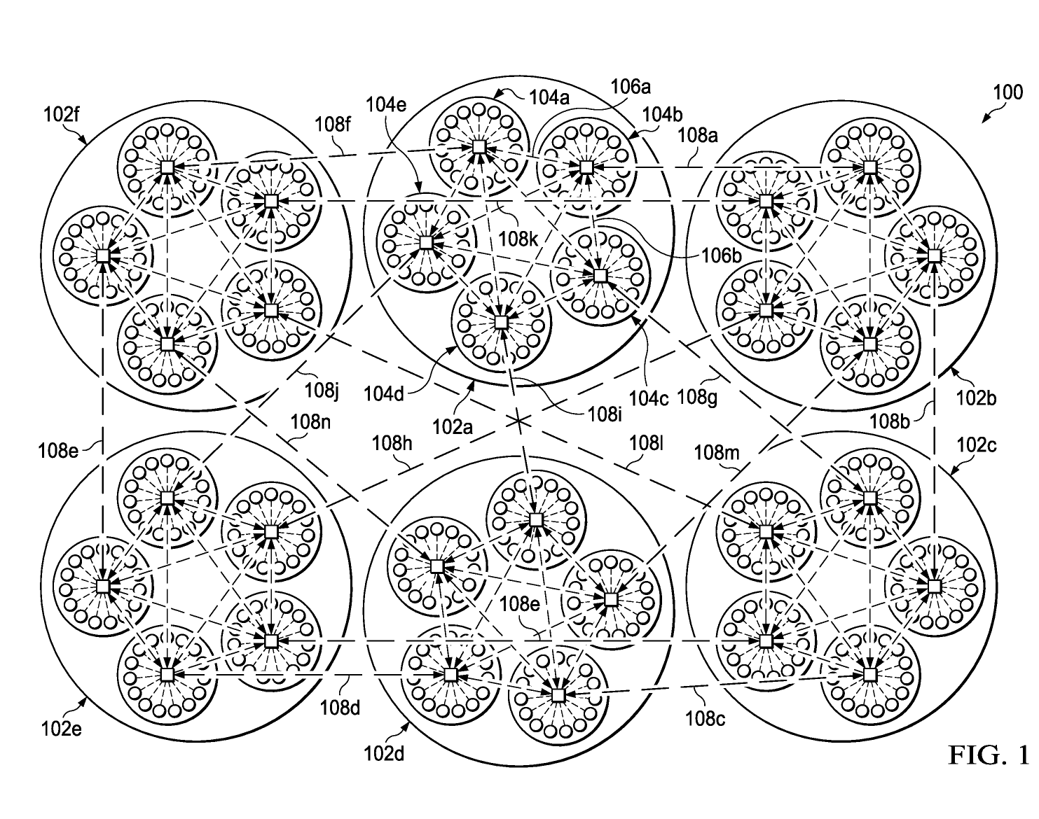

FIG. 1 is a simplified block diagram of a communication system 100 to illustrate an example use of a collective communication operation. Communication system 100 can include a plurality of groups 102a-102f. Each group can include one or more collection of nodes. For example, group 102a can include collection of nodes 104a-104e. Each collection of nodes can be coupled to at least one other collection of nodes using a collection of nodes path. For example, collection of nodes 104a can be coupled to collection of nodes 104b using collection of nodes path 106a. Each group can be coupled to one or more other groups using a group path. For example, group 102a can be coupled to group 102b using group path 108a, to group 102c using group path 108g, to group 102d using group path 108i, to group 102e using group path 108j, and to group 102f using group path 108f. In addition, group 102b can be coupled to group 102c using group path 108b, to group 102d using group path 108m, to group 102e using group path 108h, and to group 102f using group path 108k. Also, group 102c can be coupled to group 102d using group path 108c, to group 102e using group path 108e, and to group 102f using group path 108i. Further, group 102d can be coupled to group 102e using group path 108d and to group 102f using group path 108n. In addition, group 102e can be coupled to group 102f using group path 108e. Each group path 108a-108e can include multiple connections or communication paths to enable parallel communications between groups.

Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs.

Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Users have more communications choices than ever before. A number of prominent technological trends are currently afoot (e.g., more computing devices, more connected devices, etc.). One current trend is interconnected networks. Interconnected networks are a critical component of some modern computer systems. From large scale systems to multicore architectures, the interconnected network that connects processors and memory modules significantly impacts the overall performance and cost of the system. As processor and memory performance continue to increase, multicomputer interconnected networks are becoming even more critical as they largely determine the bandwidth and latency of remote memory access.

One type of interconnected network allows for parallel computing. Parallel computing is a type of computation in which many calculations or the execution of processes are carried out simultaneously. One aspect of parallel computing is a collective communication operation. For example, a gather or scatter operation is a collective communication operation that can be performed on a parallel system.

An allgather operation is a type of gather operation that includes an event where data on each node is combined and spread over the network so each node on the network has the same (or nearly the same) data. In an allgather operation, each node collects the data from each of the other nodes. For example, node 0 contributes data d0, node 1 contributes data d1, node 2 contributes data d2, etc., and as a result, each node (e.g., node, node 0, node 1, node 2, etc.) has the data from the other nodes (e.g., the data array of d0, d1, d2, etc.).

In a scatter operation, the opposite of the allgather operation occurs. More specifically, in a gather operation, data is gathered on a single process while in a scatter operation a single process has the data that is to be distributed to other processes. For example, process P0 has data d0, d1, d2, d3. The scatter operation results in process P0 with data d0, process P1 with data d1, process P2 with data d2 and so on. Generally, a collective communication operation can be thought of as a communication that involves a group of processes. What is needed is an efficient system and method for a collective communication operation, especially on a multi-level direct network topology.

Known solutions like recursive doubling and ring based approaches are well known algorithms for an allgather operation but these methods are oblivious to network topology. Also, the recursive doubling approach can cause network contention because of the nature of its communication pattern. A ring based approach for an allgather operation can avoid contention but has significantly large number of phases (as many as there are nodes participating in the collective) that lead to a large runtime.

A communication system that allows for a collective communication operation, as outlined in FIG. 1, can resolve these issues (and others). In an example, communication system 100 can be configured to facilitate a collective communication operation and identify and consolidate one or more processes on a node in a first collection of nodes. The consolidated data can be communicated to a second node in the first collection of nodes. The first collection of nodes is part of a first group of nodes and the consolidated data can be communicated to a third node in a second collection of nodes, where the second collection of nodes is part of the first group of nodes. In addition, the consolidated data can be communicated to a fourth node, where the fourth node is part of a third collection of nodes, where the third collection of nodes is in a second group of nodes.

Also, in an allgather or scatter process, the node can receive data from the second node, where the data is related to an allgather processor or a scatter process. If the data is related to an allgather process, the received data can be combined with the consolidated data before communicating the combined consolidated data to another node, in another collection of nodes, in another group of nodes. In some examples, the consolidated data is communicated using a pipeline, where the pipeline includes more than one communication path and the consolidated data is divided into portions, where the number of portions is equal to the number of communication paths. The node may be part of an interconnected network and may be part of a multi-tiered dragonfly topology network or some other parallel computing architecture.

One messaging system designed for parallel computing architectures is message passing interface (MPI). MPI defines an application programming interface (API) for message passing in parallel programs. MPI defines both point-to-point communication routines, such as sends and receives between pairs of processes and collective communication routines that involve a group of processes that need to perform some operation together. For example, MPI can define broadcasting data from a root process to other processes and finding a global minimum or maximum of data values on all processes (called a reduction operation). Collective communication routines provide the user with a simple interface for commonly required operations and can also enable a system to optimize these operations for a particular architecture. As a result, collective communication is widely and frequently used in many applications and the performance of collective communication routines is often critical to the performance of the overall system or application. In an example, communication system 100 can be configured to perform a collective communication operation, such as a gather or scatter collective communication operation, on a multi-level direct network topology (e.g., dragonfly topology). In an example implementation, the collective communication operation can be implemented for a multi-tier dragonfly topology.

A multi-tier dragonfly topology has a much more complicated structure than the simple two-tier topologies. This difference can allow for several enhancements such as scattering or distributing data across nodes in a switch so that as many as possible inter-switch links can be utilized simultaneously. Also, in a multi-tier dragonfly topology, there are multiple links (e.g., communication paths) per inter-group connection. These links can be utilized in a collective communication operation (e.g., an allgather operation) by causing multiple nodes to send data simultaneously through the intergroup connection. Further, in many other network topologies, nodes are capable of sending data simultaneously on all links originating from the node. This is not true in the multi-tier dragonfly topology. In the multi-tier dragonfly topology, typically there is only one outgoing connection from the node to the switch. The switch provides the node with direct connection to other nodes in the switch, however, the data cannot be sent simultaneously to other nodes in the collection of nodes. In some two-tier dragonfly topologies, the presence of many more links and multiple levels of links as compared to the two-tier topology may require many more steps of intelligent data flow rather than a simple three-step procedure as with other network topologies.

In an implementation, communication system 100 can leverage the hierarchical structure of the dragonfly network, reduce or completely avoid network contention by organizing the communication pattern, leverage available bandwidth by scattering the data across compute nodes, have enough nodes in each switch/group to utilize the all-to-all connections, and/or pipeline the final broadcast by segmenting large messages in to small chunks. In a specific example, communication system 100 can be configured to avoid contention and have a performance level that is within one percent (1%) of a naïve lower bound.

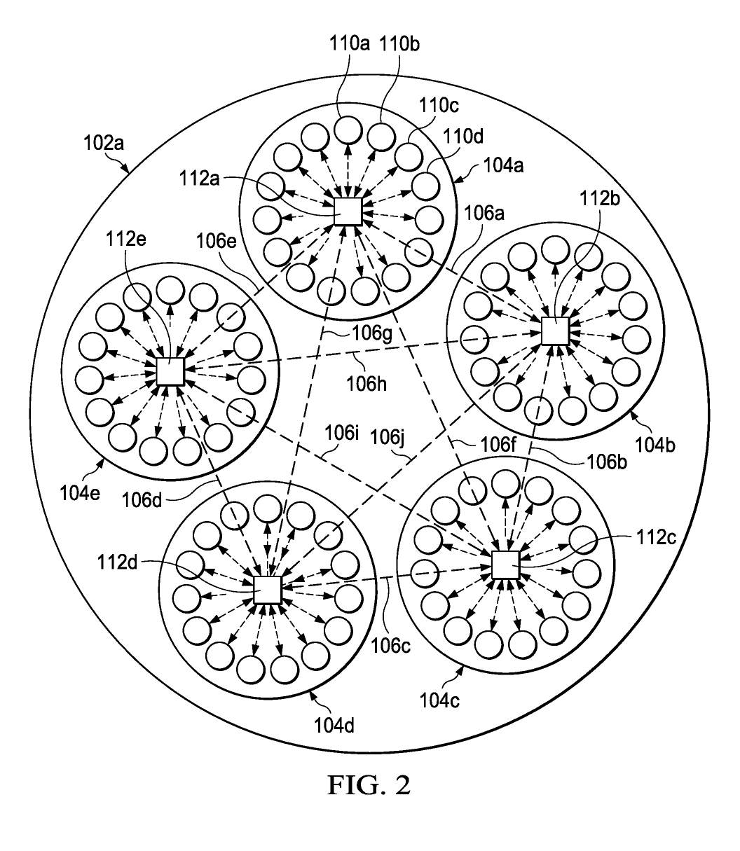

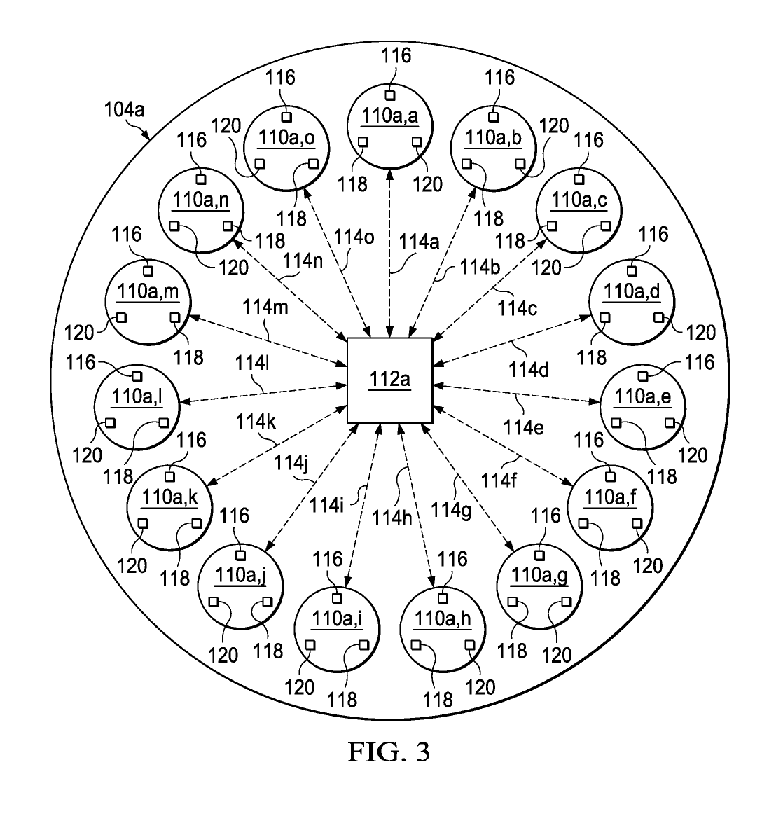

In a specific example, communication system 100 can be configured to allow for a gather or scatter collective operation on a multi-tier dragonfly topology or some other interconnected network topology. In a gather or scatter collective operation, most or every process contributes a data item. The contributed data item is collected or consolidated (e.g., into memory, a single buffer, etc.) and the consolidated data can be made available to all the nodes. As explained above, in a dragonfly topology, there are direct connections at each tier of the topology. At the first tier of a three tier dragonfly topology, multiple nodes (e.g., nodes 110a,a-110a,o illustrated in FIG. 3) are directly connected to each other through a switch (e.g., switch 112a). At the second tier, multiple switches can be directly connected to each other to form a group (as illustrated in FIG. 2). At the third tier, the groups are directly connected to each other through the switches inside each group (as illustrated in FIG. 3).

Communication system 100 can be configured to perform a data exchange in a hierarchical topology aware manner. In an example, as illustrated in FIG. 3, the data can be exchanged across nodes within the same switch (e.g., nodes 110a,a-110a,o in collection of nodes 104a can exchange data using switch 112a). Then, as illustrated in FIG. 2, data can be exchanged between nodes coupled to different switches (e.g., nodes in collection of nodes 104a are coupled to switch 112a and nodes in collection of nodes 104b are coupled to switch 112b) in the same group (e.g., nodes in collection of nodes 104a and nodes in collection of nodes 104b are in the same group 102a). All nodes coupled to a switch can send data concurrently in order to maximally utilize the all-to-all connections across switches so each node in a collection of nodes has the same data. This is followed by a data exchange across nodes in different groups in such a way that each group has the data of every other group. In order to avoid network congestion, each node sends data to (and receive data from) only those groups to which their switch is in direct communication. Additionally, multiple nodes in a switch can send this data simultaneously in order to fully utilize the multiple links that connect two groups.

In some examples, such as when all the nodes in the network are not being used for a specific operation, it may be necessary for a node to send data to another node that is not directly in communication with the node. In these examples, the path may take one or more hops or go through one or more switches. For example, collection of nodes 104e in group 102a is directly in communication with a node in group 102e. If none of the nodes in collection of nodes 104e is involved in the process, then a node in collection of nodes 104a can communicate data to a node in group 102d that is involved in the process and that node in group 102d can communicate the data to a node in group 102e.

Communication system 100 can be configured such that the entire system data can be distributed across nodes in each group that are participating the collective process. The data can be gathered on every node by the nodes exchanging data across switches such that each node coupled to each switch has the data of the entire group. Then, nodes in a collection of nodes exchange data with each other resulting in each node having the data of the entire system. The data can be broadcasted to other processes on the node. In an example, the broadcast can be pipelined by dividing messages into chunks and broadcasting each chuck as it arrives instead of waiting for the entire data transfer to be complete.

The process leverages the all-to-all direct connections at each level of the dragonfly topology and helps to ensures that the source and destination of the messages are within the same set of nodes (where a set of nodes is either a collection of nodes or a group of nodes) corresponding to a specific level of the topology. Therefore, there is no, or limited, network congestion or interference because the messages are contained within the specific level of the topology. Communication system 100 can help ensure that there are enough nodes (and that they have the required data) so that the all-to-all connections are maximally utilized.

In a specific implementation of a three-tier dragonfly topology, the three-tier dragonfly topology may have sixty four (64) processes/node, sixteen (16) nodes/switch, thirty-two (32) switches/group and one hundred and twenty eight (128) groups. Each process can contribute eight (8) bytes of data. The final data size may be 32 MB (8*64*16*32*128=32 MB). The system can be configured to gather data from all the processes on a node on to a single process per node (called the leader process of that node). Nodes within a collection of nodes are directly connected to each other and the nodes exchange each other's data in an all-to-all exchange pattern. This allows each node to have the data of every other node in communication with the same switch. The nodes can send the data to nodes in other collections of nodes. In an example, there can be thirty one (31) links that connect a switch to 31 other switches or 31 links that connect a collection of nodes to 31 other collection of nodes.

In addition, there may be 16 nodes included in each collection of nodes. Therefore, there is enough bandwidth available for every node to continuously send data. This allows every node to have the data of an entire group. The nodes can send data across groups such that each group has the data of the entire system and the data is distributed across nodes in the group. Nodes in a collection of nodes can send the data to those groups that are directly connected to the switch in the collection of nodes. The data being sent can be distributed across nodes in the destination switch (e.g., the switch coupled to the nodes that will receive the data). The nodes across switches in the same group of nodes can exchange data so that nodes in each collection of nodes have the data of the entire system. Then, nodes within each collection of nodes can exchange the data such that every node has the data of the entire system. There is no contention because the process ensures that the communication occurs within a switch and the data is broadcasted to other processes on the node. Since the message size is very large (e.g., about 30 MB), the message can be broadcast as a pipeline where the message is divided into chunks and the broadcast is done concurrently as these chunks arrive. Note that the number of nodes, collection of nodes, groups, etc. does not need to be symmetric or similar and one node can communicate with different nodes in different collection of nodes or groups. It should be appreciated that the teachings and examples provided herein are readily scalable and applicable to a variety of collective network architectures.

Turning to the infrastructure of FIG. 1, communication system 100 in accordance with an example embodiment is shown. Generally, communication system 100 can be implemented in any type or topology of networks the enables or allows for the teaching and examples disclosed herein. Communication system 100 represent a series of points or nodes of interconnected communication paths for receiving and transmitting packets of information that propagate through communication system 100. Communication system 100 offers a communicative interface between nodes, and may be configured as a collective network, parallel computing network, multi-level direct network, dragonfly topology network, multi-level dragonfly topology network, a local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates collective communications in a network environment, or any suitable combination thereof, including wired and/or wireless communication.

In communication system 100, network traffic, which is inclusive of packets, frames, signals (analog, digital or any combination of the two), data, etc., can be sent and received according to any suitable communication messaging protocols. Suitable communication messaging protocols can include MPI, a multi-layered scheme such as Open Systems Interconnected (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

Turning to FIG. 2, FIG. 2 is a simplified block diagram of a portion of communication system 100. Each plurality of groups 102a-102f (illustrated in FIG. 1) can include collection of nodes 104a-104e. Each collection of nodes 104a-104e can include a plurality of nodes. For example, collection of nodes 104a can include nodes 110a-110d. While collection of nodes 104a includes more nodes than those referenced by nodes 110a-110d, this is done for simplification and illustration purposes. Each node included in collection of nodes 104a can be in communication using switch 112a. For example, node 110a can be in communication with node 110b, 110c, and 110d using switch 112a. Also, each node in the other collection of nodes 104b-104e can be in communication using a switch in the collection of nodes. For example, collection of nodes 104b can include switch 112b, collection of nodes 104c can include switch 112c, collection of nodes 104d can include switch 112d, and collection of nodes 104e can include switch 112e. Each node in a collection of nodes is in communication with each of the other nodes in the collection of nodes using a common switch.

Each collection of nodes 104a-104e can be in communication with another collection of nodes using a collection of nodes path. For example, collection of nodes 104a can be in communication with collection of nodes 104b using collection of nodes path 106a, with collection of nodes 104c using collection of nodes path 106f, with collection of nodes 104d using collection of nodes path 106g, and with collection of nodes 104e using collection of nodes path 106e. Collection of nodes 104b can be in communication with collection of nodes 104c using collection of nodes path 106b, with collection of nodes 104d using collection of nodes path 106j, and with collection of nodes 104e using collection of nodes path 106h. Collection of nodes 104c can be in communication with collection of nodes 104d using collection of nodes path 106c and with collection of nodes 104e using collection of nodes path 106i. Collection of nodes 104d can be in communication with collection of nodes 104e using collection of nodes path 106d.

Turning to FIG. 3, FIG. 3 is a simplified block diagram of a portion of communication system 100. Each collection of nodes 104a-104e (illustrated in FIG. 1) can include a plurality of nodes. For example, collection of nodes 104a can include nodes 110a,a-110a,o. Each node 110a,a-110a,o can be in communication with switch 112a using node paths 114a-114o respectively. For example, node 110a,a can be in communication with switch 112a using node path 114a, node 110a,b can be in communication with switch 112a using node path 114b, node 110a,c can be in communication with switch 112a using node path 114c, etc. This allows each node to be able to communication with any other node in collection of nodes 104a. Each node 110a,a-110a,o can include a processor 116, memory 118, and a data engine 120. Data engine 120 can be configured to collect data from process running on the node, communicate the collected data to other nodes, receive data from other nodes, divide the data into segments, and other functions or operations that help enable the features, activities, examples, etc. discussed herein.

Nodes (e.g., nodes 110a,a-110a,o) and switches (e.g., switches 112a-112e) can include memory elements (e.g., memory 116) for storing information to be used in the operations outlined herein. Each node (e.g., nodes 110a,a-110a,o) and switch (e.g., switches 112a-112e) may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

Additionally, each node (e.g., nodes 110a,a-110a,o) and switch (e.g., switches 112a-112e) may include a processor (e.g., processor 118) that can execute software or an algorithm to perform activities as discussed herein. A processor can execute any type of instructions associated with the data to achieve the operations detailed herein. In one example, each processor can transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

In an example implementation, the nodes (e.g., nodes 104a-104d) in each group of nodes 104a-104e are network elements, meant to encompass network appliances, servers (both virtual and physical), processors, modules, or any other suitable virtual or physical device, component, element, or object operable to process and exchange information in a collective communication network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as the nodes (e.g., nodes 104a,a-104a,o) in each group of nodes 104a-104e and switches 112a-112e may include software modules (e.g., data engine 120) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

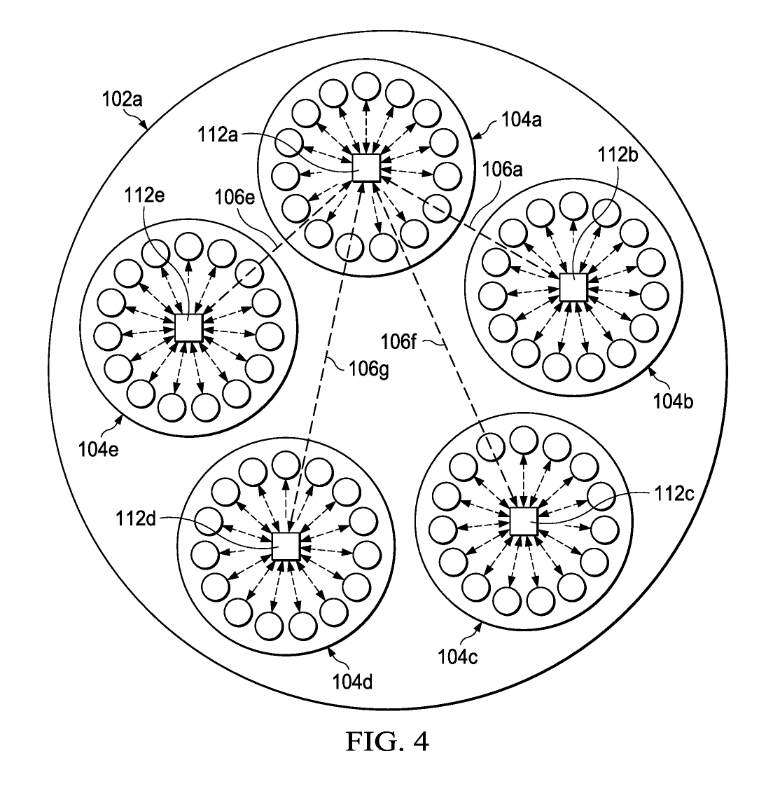

Turning to FIG. 4, FIG. 4 is a simplified block diagram of a portion of communication system 100. Any node in each of collection of nodes 104a-104e can communicate with another node in each of the other collection of nodes using a collection of nodes path. For example, any node in collection of nodes 104a can communicate with another node in collection of nodes 104b using switch 112a, collection of nodes path 106a, and switch 112b, can communicate with another node in collection of nodes 104c using switch 112a, collection of nodes path 106f, and switch 112c, can communicate with another node in collection of nodes 104d using switch 112a, collection of nodes path 106g, and switch 112d, and can communicate with another node in collection of nodes 104e using switch 112a, collection of nodes path 106e, and switch 112e.

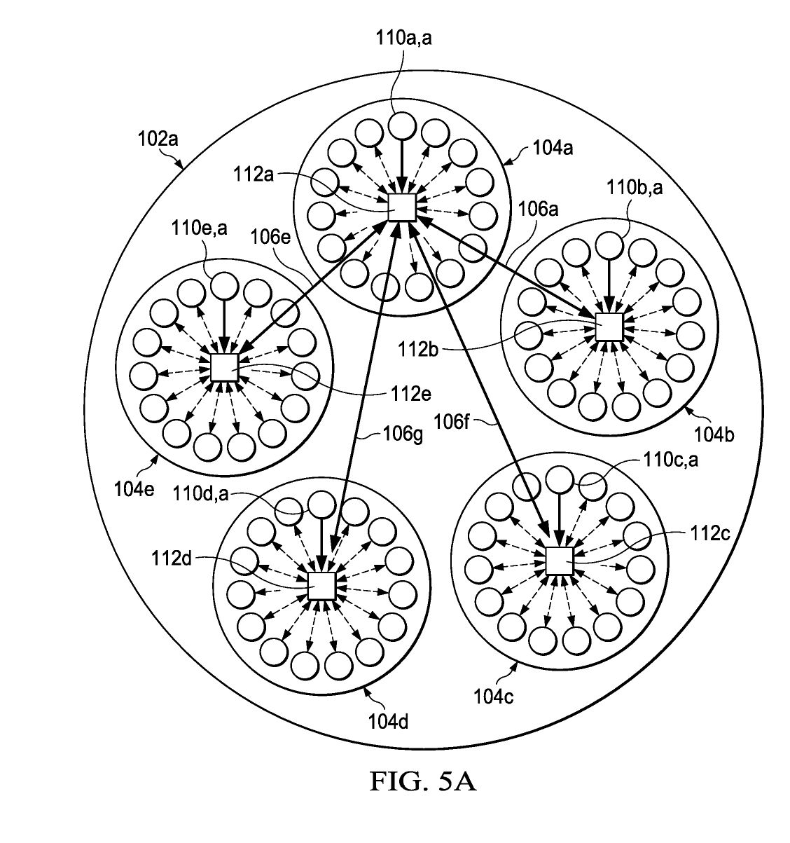

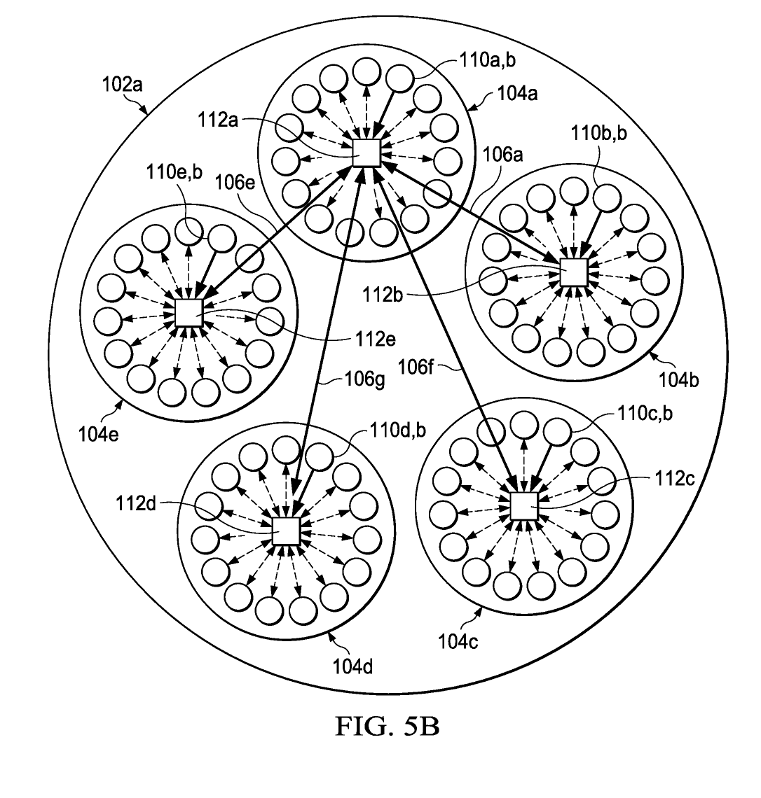

Turning to FIG. 5A, FIG. 5A is a simplified block diagram of a portion of communication system 100. As illustrated in FIG. 5A, node 110a,a (i.e., node 110a, in collection of nodes 104a) can communicate with node 110b,a (i.e., node 110a in collection of nodes 104b) using switch 112a, collection of nodes path 106a, and switch 112b. In addition, node 110a,a can communicate with node 110c,a in collection of nodes 104c using switch 112a, collection of nodes path 106f, and switch 112c. Further, node 110a,a can communicate with node 110d,a in collection of nodes 104d using switch 112a, collection of nodes path 106g, and switch 112d. Also, node 110a,a can communicate with node 110e,a in collection of nodes 104e using switch 112a, collection of nodes path 106e, and switch 112e. Using this process, data on node 110a,a can be communicated to each of node 110b,a-110e,a.

Turning to FIG. 5B, FIG. 5B is a simplified block diagram of a portion of communication system 100. As illustrated in FIG. 5B, node 110a,b in collection of nodes 104a can communicate with node 110b,b in collection of nodes 104b using switch 112a, collection of nodes path 106a, and switch 112b. Further, node 110a,b can communicate with node 110c,b in collection of nodes 104c using switch 112a, collection of nodes path 106f, and switch 112c. Also, node 110a,b, can communicate with node 110d,b in collection of nodes 104d using switch 112a, collection of nodes path 106g, and switch 112d. In addition, node 110a,b, can communicate with node 110e,b in collection of nodes 104e using switch 112a, collection of nodes path 106e, and switch 112e. Using this process, data on node 110a,b can be communicated to each of node 110b,b-110e,b. The examples illustrated in FIGS. 5A and 5B can be repeated for nodes 110a,c, 110a,d, 110a,e, etc. and a corresponding node 110b,c 110b,d, 110b,e, etc. for each collection of nodes 104b-104e.

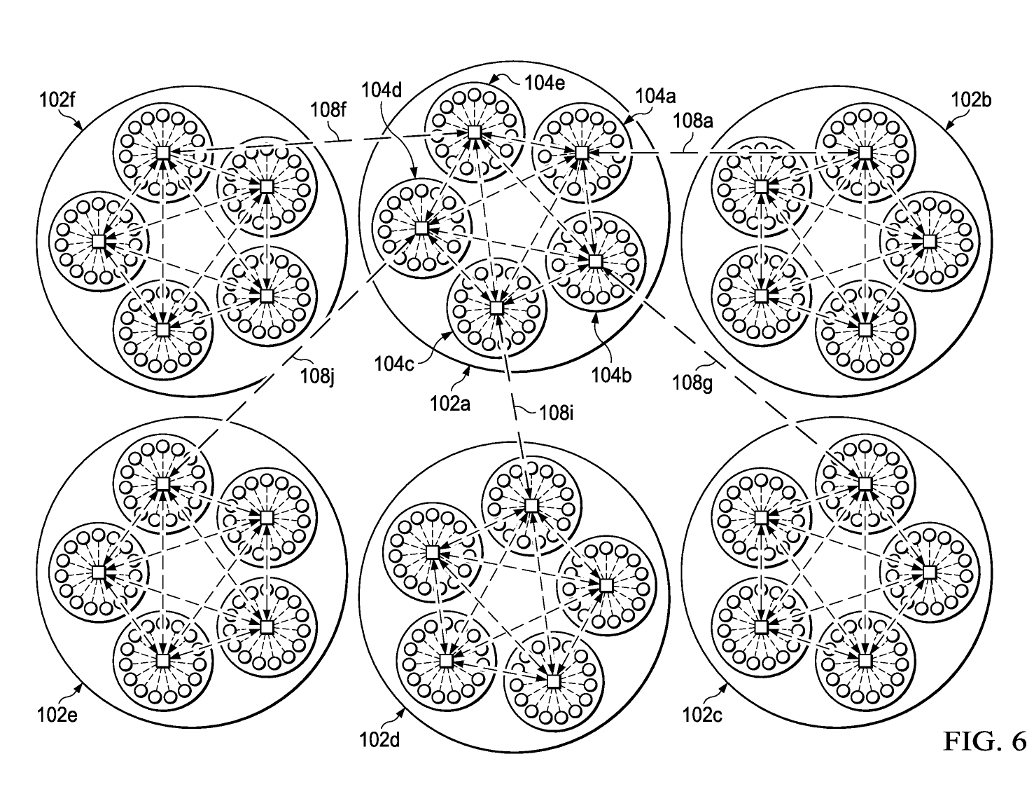

Turning to FIG. 6, FIG. 6 is a simplified block diagram of a portion of communication system 100. Any node in each of collection of nodes 104a-104e (illustrated in FIG. 2) in group 102a can communicate with another node in each of the other collection of nodes in another group using a group path. For example, any node in collection of nodes 104a in group 102a can communicate with another node in group 102b using a switch (e.g., switch 112a) and group path 108a. Any node in collection of nodes 104b in group 102a can communicate with another node in group 102c using a switch (e.g., switch 112b) and group path 108g. Any node in collection of nodes 104c in group 102a can communicate with another node in group 102d using a switch (e.g., switch 112c) and group path 108i. Any node in collection of nodes 104d in group 102a can communicate with another node in group 102e using a switch (e.g., switch 112a) and group path 108j. Any node in collection of nodes 104e in group 102a can communicate with another node in group 102e using a switch (e.g., switch 112a) and group path 108f.

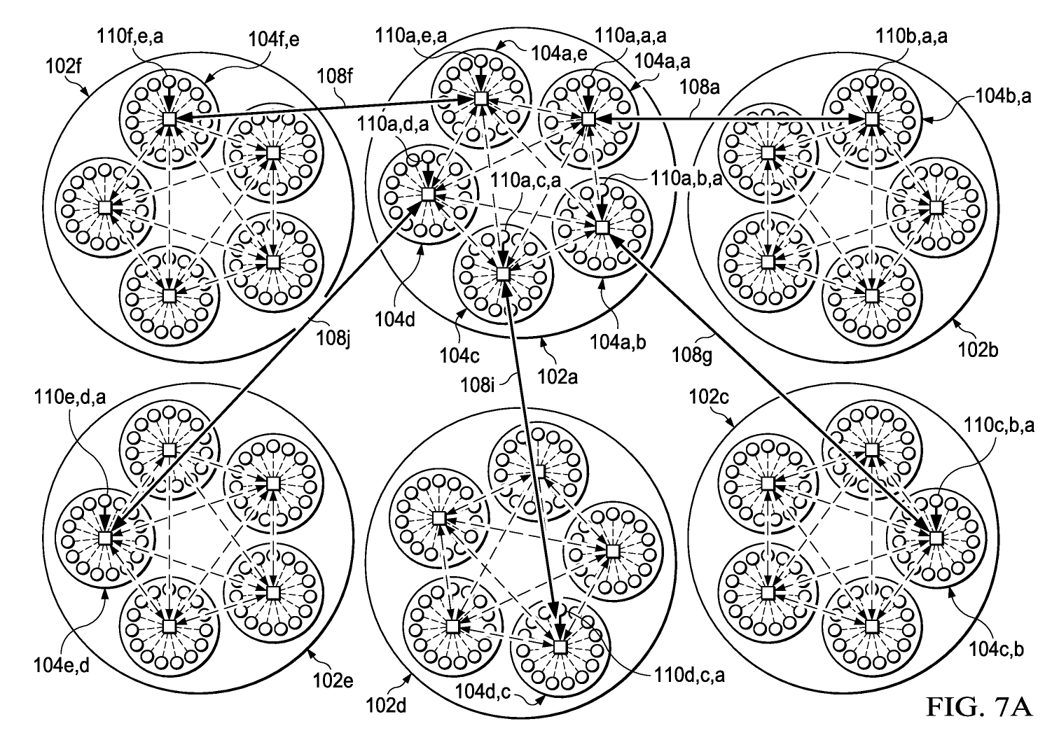

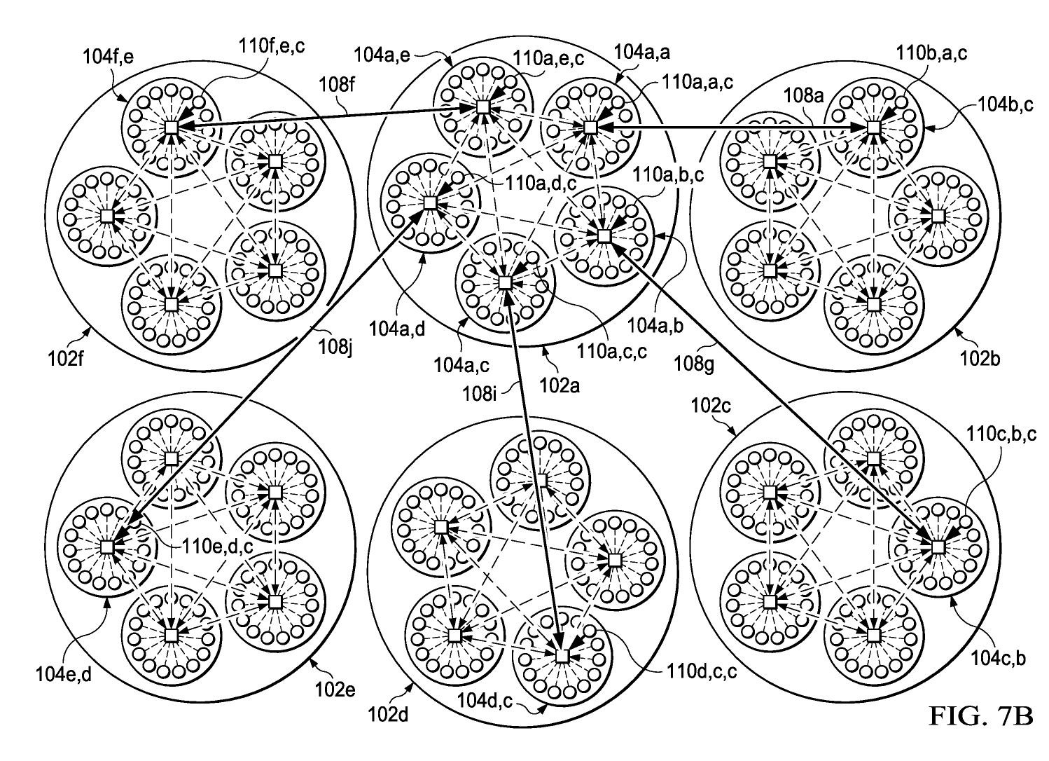

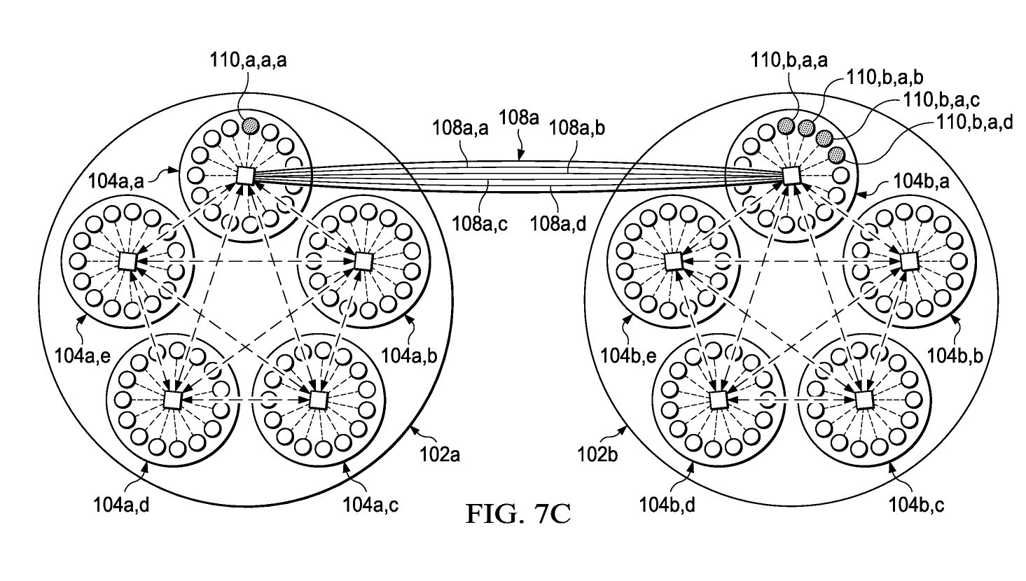

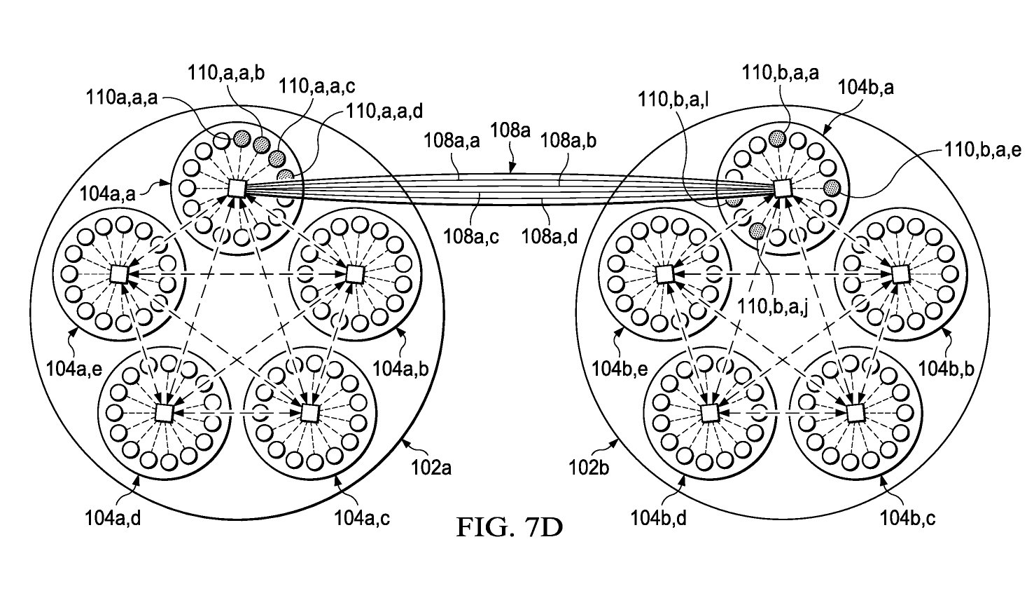

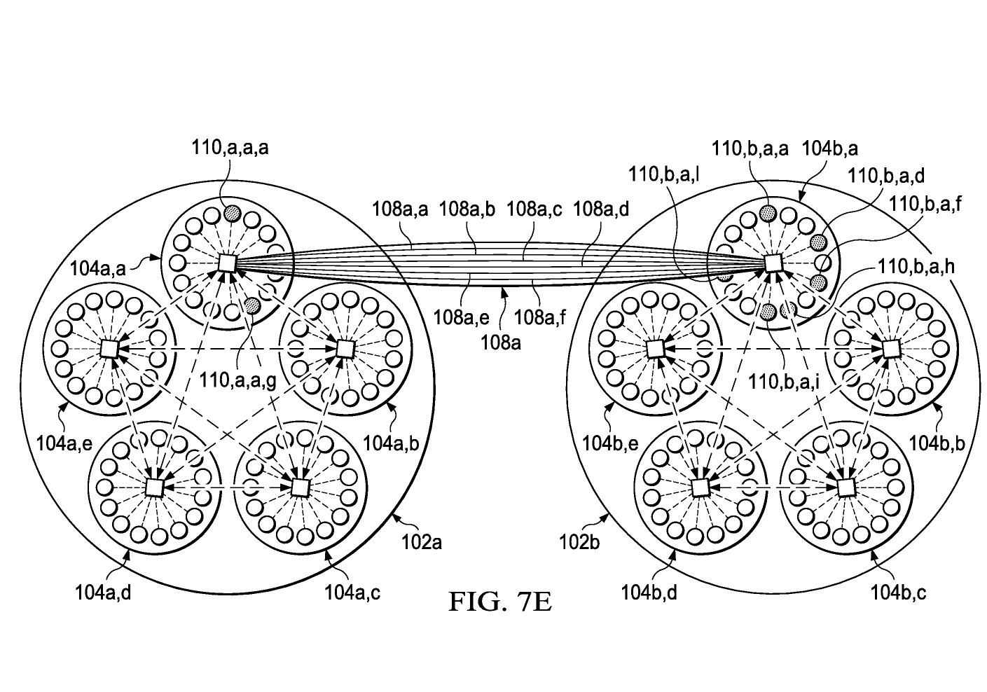

Turning to FIG. 7A, FIG. 7A is a simplified block diagram of a portion of communication system 100. As illustrated in FIG. 7A, node 110a,a,a (i.e., node 110a, in collection of nodes 104a, in group 102a) can communicate with node 110b,a,a (i.e., node 110a, in collection of nodes 104a, in group 102b) using a switch (e.g., switch 112a) and group path 108a. Node 110a,b,a (i.e., node 110a, in collection of nodes 104b, in group 102a) can communicate with node 110c,b,a (i.e., node 110a, in collection of nodes 104b, in group 102c) using a switch (e.g., switch 112b) and group path 108g. Node 110a,c,a (i.e., node 110a, in collection of nodes 104c, in group 102a) can communicate with node 110d,c,a (i.e., node 110a, in collection of nodes 104c, in group 102d) using a switch (e.g., switch 112c) and group path 108i. Node 110a,d,a (i.e., node 110a, in collection of nodes 104d, in group 102a) can communicate with node 110e,d,a (i.e., node 110a, in collection of nodes 104d, in group 102e) using a switch (e.g., switch 112d) and group path 108j. Node 110a,e,a (i.e., node 110a, in collection of nodes 104e, in group 102a) can communicate with node 110f,e,a (i.e., node 110a, in collection of nodes 104e, in group 102f) using a switch (e.g., switch 112e) and group path 108f.

Turning to FIG. 7B, FIG. 7B is a simplified block diagram of a portion of communication system 100. As illustrated in FIG. 7B, node 110a,a,c (i.e., node 110c, in collection of nodes 104a, in group 102a) can communicate with node 110b,a,c (i.e., node 110c, in collection of nodes 104a, in group 102b) using a switch (e.g., switch 112a) and group path 108a. Node 110a,b,c (i.e., node 110c, in collection of nodes 104b, in group 102a) can communicate with node 110c,b,c (i.e., node 110c, in collection of nodes 104b, in group 102c) using a switch (e.g., switch 112b) and group path 108g. Node 110a,c,c (i.e., node 110c, in collection of nodes 104c, in group 102a) can communicate with node 110d,c,c (i.e., node 110c, in collection of nodes 104c, in group 102d) using a switch (e.g., switch 112c) and group path 108i. Node 110a,d,c (i.e., node 110c, in collection of nodes 104d, in group 102a) can communicate with node 110e,d,c (i.e., node 110c, in collection of nodes 104d, in group 102e) using a switch (e.g., switch 112d) and group path 108j. Node 110a,e,c (i.e., node 110c, in collection of nodes 104e, in group 102a) can communicate with node 110f,e,c (i.e., node 110c in collection of nodes 104e, in group 102f) using a switch (e.g., switch 112e) and group path 108f.

Turning to FIG. 7C, FIG. 7C is a simplified block diagram of a portion of communication system 100. Group path 108a can include multiple communication paths. For example, as illustrated in FIG. 7C, group path 108a can include communication path 108a,a, communication path 108a,b, communication path 108a,c, and communication path 108a,d. Node 110a,a,a, can be configured to divide the data it will communicate to the other nodes in group 102b into as many communication paths that are available in group path 108a. For example, node 110a,a,a may divide the data into four parts and send each part to four nodes in group 102b. This allows all the data to be sent relatively quickly instead of sending all the data on one commutation path which would take longer and leave the remain three communication paths unused. In an example, if a node (e.g., node 110a,a,a) has only one node path (e.g., node path 114a) to the switch (e.g., switch 112a) associated with the node, the node can send data to only one node at a time because there is only one link or node path connecting the node to the switch. However, the node can still divide or chunk the data and send the data to multiple nodes in the destination group one by one, instead of sending to just one node because multiple nodes in the destination group can send the data in parallel to other nodes in the destination group.

In another example, node 110a,a,a may be in communication with switch 112a using two or more node paths. In a specific example, node 110a,a,a can divide the data into four parts and send the first part to node 110b,a,a in group 102b using communication path 108a,a, the second part to node 110b,a,b in group 102b using communication path 108a,b, the third part to node 110b,a,c in group 102b using communication path 108a,c, and the fourth part to node 110b,a,d in group 102b using communication path 108a,d. Note that node 110a,a,a may send each part of the data to any node in group 102b that is coupled to node 110a,a,a by a switch (e.g., switch 112a) and that that data being sent may be divided into as many communication paths that are included in group path 108a. Once the nodes (e.g., nodes 110b,a,a-110b,a,d) receive the portion of data from node 110a,a,a, the nodes can communicate the received portion to the other nodes until each nodes has the complete data. Each node (e.g. nodes 110a,a-110a,o illustrated in FIG. 3) may be coupled to a switch (e.g., switch 112a) by more than one node path. More specifically, node 110a,a may be coupled to switch 112a by more than one node path (e.g., two, three, or four, etc. node paths) and not just single node path 114a. In another example, communication system 100 can include two or more independent and identical dragonfly networks where at least one node is coupled to both networks. The node or nodes that are coupled to both networks can send messages in parallel using the two networks.

Turning to FIG. 7D, FIG. 7D is a simplified block diagram of a portion of communication system 100. Referring back to FIG. 3, each node in collection of nodes 104a has the same data. The data can be divided into as many communications paths that are included in group path 108. As illustrated in FIG. 7D, group path can include four communications paths, communication path 108a,a, communication path 108a,b, communication path 108a,c, and communication path 108a,d. Using data engine 120, the data on the nodes in collection of nodes 110a,a, can be divided into four parts and four nodes from collection of nodes 110a,a can send a portion of the data on a communication path. For example, node 110a,a,a can send a first portion of the data to node 110b,a,a on group path 108a,a, node 110a,a,b can send a second portion of the data to node 110b,a,e, on communication path 108a,b, node 110a,a,c can send a third portion of the data to node 110b,a,j on communication path 108a,c, and node 110a,a,d, can send a fourth portion of the data to node 110b,a,l on communication path 108a,d. Note that any node in collection of nodes may send each part of the data to any node in group 102b that is coupled to node 110a,a,a by group path 108a and that that data being sent may be divided by as many communication paths that are included in group path 108a. Once the nodes (e.g., nodes 110b,a,a, 110b,a,e, 110b,a,j, and 110b,a,l) receive the portion of data from nodes 110a,a,a-110a,a,d, the nodes can communicate the received portion to the other nodes until each nodes has the complete data set.

Turning to FIG. 7E, FIG. 7E is a simplified block diagram of a portion of communication system 100. Referring back to FIG. 3, each node in collection of nodes 104a has the same data. Using data engine 120, the data can be divided into as many communication paths that are included in group path 108. As illustrated in FIG. 7E, group path 108a can include six communications paths, communication path 108a,a, communication path 108a,b, communication path 108a,c, communication path 108a,d, communication path 108a,e and communication path 108a,f. The data on the nodes in collection of nodes 110a,a, can be divided into six parts and one or more nodes may send each part along a communication path. For example, as illustrated in FIG. 7E, node 110a,a,a may send a first part of the data to node 110b,a,a, on communication path 108a,a, a second part of the data to node 110b,a,d on communication path 108a,b, and a third part of the data to node 110b,a,f on communication path 108a,c. Node 110a,a,g may send a fourth part of the data to node 110b,a,h, on communication path 108a,d, a fifth part of the data to node 110b,a,i on communication path 108a,e, and a sixth part of the data to node 110b,a,l on communication path 108a,f. Each data engine 120 on a node can be configured to determine if the data to be communicated should be divided into parts or segments, what node is sending what part or segment, and what the receiving node will be receiving each part or segment.

FIGS. 7A-7E illustrate some examples of the many different ways and combinations that data may be transferred from one group to another group. As illustrated in FIGS. 7C-7E, one common feature to transfer the data is to divide the data into as many channels as are included in the communication path that couples one group to the other group. One or more nodes in a collection of nodes in a group may send a portion of the data to nodes in another collection of nodes in the another group in parallel. Because each node in a collection of nodes has the same data, it does not matter how many or what nodes are sending the data or what nodes are receiving the data so long as each channel on the group path is being used to communicate the data. Because each node in a collection of nodes can communicate the received data to the other nodes in the collection of nodes, it does not matter what nodes are receiving the data.

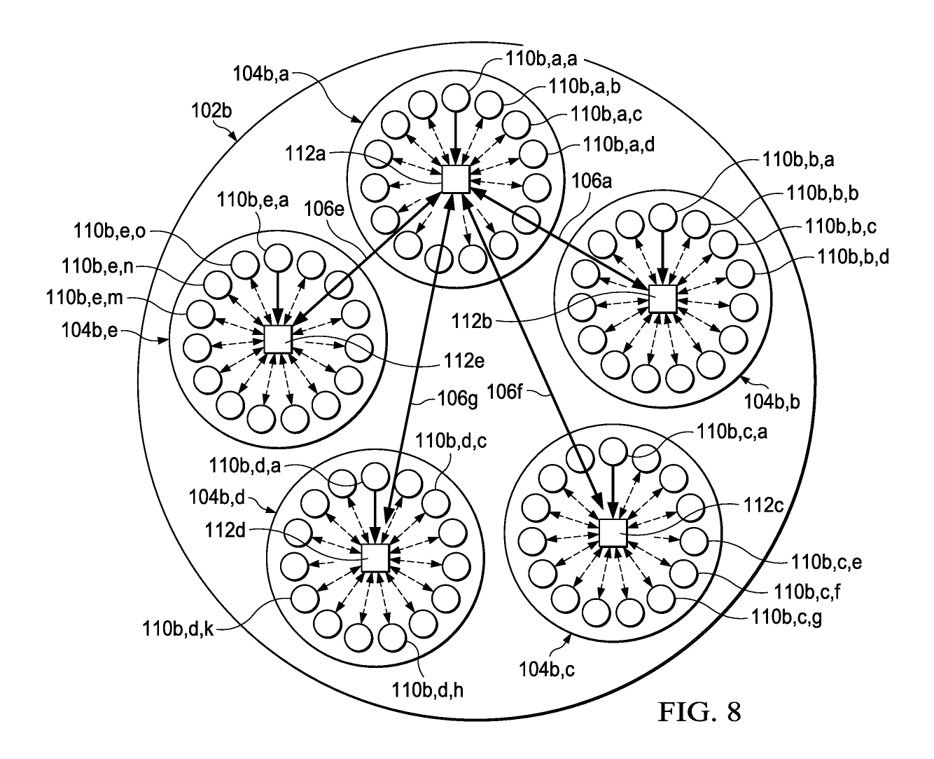

Turning to FIG. 8, FIG. 8 is a simplified block diagram of a portion of communication system 100. Once a collection of nodes in a group has received data from another collection of nodes in another group, the data needs to be communication to the other collections of nodes in the group. For example, once data from one or more nodes in collection of nodes 104a,a has been received by nodes in collection of nodes 104b,a, the data needs to be communication to other collections of nodes in group 102b. This can be done by dividing the data into as many collection of nodes that are include in group 102b minus one. For example, as illustrated in FIG. 8, group 102b includes five collection of nodes. Because one group is communicating the data to the other collection of nodes, the number of the collection of nodes in the group needs to be subtracted by one leaving four collection of nodes. The data in collection of nodes that needs to be communicated to the other collection of nodes can be divided by four and four nodes in collection of nodes 104b,a can send a portion of the data to another collection of nodes. For example, node 110b,a,a can send a first portion of the data to node 110b,b,a in collection of nodes 104b,b. Node 110b,a,b can send a second portion of the data to node 110b,c.e in collection of nodes 104b,c. Node 110b,a,c, can send a third portion of the data to node 110b,d,k in collection of nodes 104b,d. Node 110b,a,d can send a fourth portion of the data to node 110b,e,o in collection of nodes 104b,e.

Using this process, collection of nodes 104b,b will include the first portion of data, collection of nodes 104b,c will include the second portion of data, collection of nodes 104b,d will include the third portion of data, and collection of nodes 104b,e will include the fourth portion of data. To communicate the remaining portions of data to each of the collection of nodes, each node can send its portion of data to a different collection of nodes. For example, node 110b,a,a can send a first portion of the data to node 110b,c,a in collection of nodes 104b,c. Node 110b,a,b can send a second portion of the data to node 110b,d.h in collection of nodes 104b,c. Node 110b,a,c, can send a third portion of the data to node 110b,e,n in collection of nodes 104b,d. Node 110b,a,d can send a fourth portion of the data to node 110b,b,d in collection of nodes 104b,e. Now collection of nodes 104b,b, will include the first and fourth portion of data, collection of nodes 104b,c will include the first and second portion of data, collection of nodes 104b,d will include the second and third portion of data, and collection of nodes 104b,e will include the third and fourth portion of data. This process can be repeated until each collection of nodes has the full data. Once each collection of nodes has the full data, each collection of nodes and communication the full data to each node in the collection of nodes as illustrated in FIG. 3.

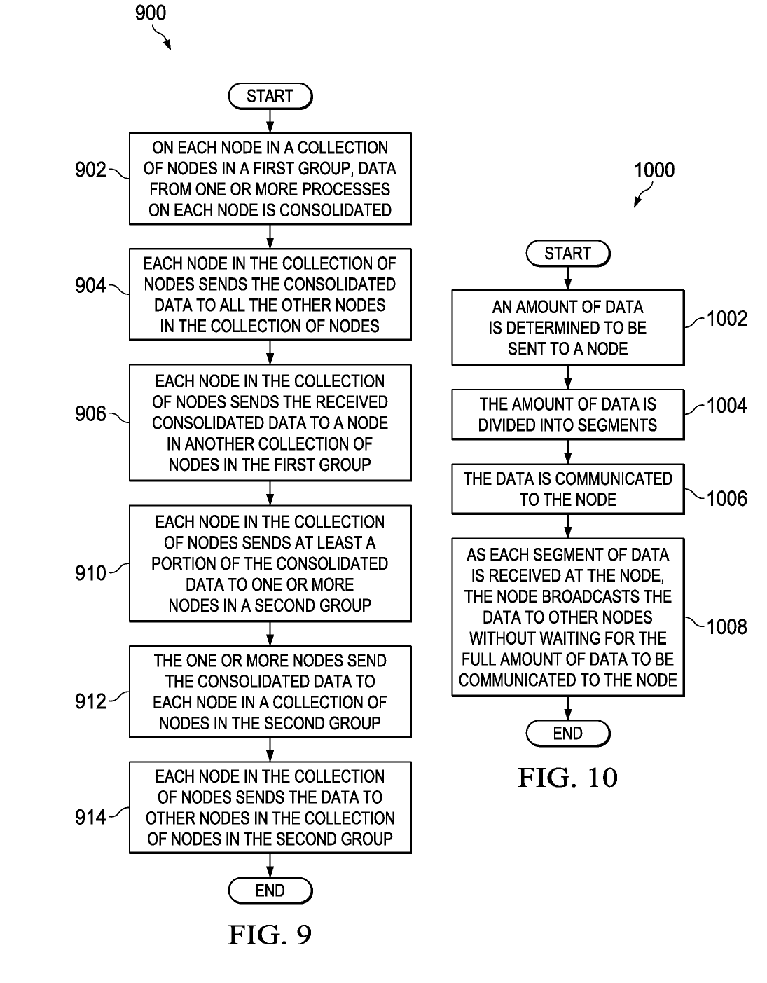

Turning to FIG. 9, FIG. 9 is an example flowchart illustrating possible operations of a flow 900 that may be associated with a collective communication operation, in accordance with an embodiment. While reference is made to a first group and a second group, each node and/or group in communication system 100 may perform one or more operations of flow 900. In an embodiment, one or more operations of flow 900 may be performed by data engine 120. At 902, on each node in a collection of nodes in a first group, data from one or more processes on each node is consolidated (into consolidated data). At 904, each node in the collection of nodes sends the consolidated data to all the other nodes in the collection of nodes. For example, with reference to FIG. 3, node 110a,a can gather data related to processes on the node into consolidated data and communicate the consolidated data to nodes 110a,b-110a,o using switch 112a. At 906, each node in the collection of nodes sends the received consolidated data to a node in another collection of nodes in the first group. For example, with reference to FIG. 5A, node 110a,a can communicate the received data to correspond nodes 110b,a, 110c,a, 110d,a, and 110e,a in collection of nodes 104b-104e respectively. At 910, each node in the collection of nodes sends at least a portion of the consolidated data to a one or more nodes in a second group. In an example, each node in a first collection of nodes in a first group can send all or a portion of the consolidated data to one or more nodes to a second collection of nodes in a second group. The second group can be in communication with the first group by a switch. For example, with reference to FIG. 5A, node 110a,a,a can communicate the consolidated data to corresponding node 110b,a,a, in collection of nodes 104b,a in group 102b. At 912, the one or more nodes send the consolidated data to each node in a collection of nodes in the second group. For example, with reference to FIG. 5A, node 110a,a can send the received consolidated data to correspond nodes 110b,a, 110c,a, 110d,a, and 110e,a in collection of nodes 104b-104e respectively. At 914, each node in the collection of nodes sends the data to other nodes in the collection of nodes in the second group. For example, with reference to FIG. 3, node 110a,a can communicate the data to nodes 110a,b-110a,o using switch 112a.

Turning to FIG. 10, FIG. 10 is an example flowchart illustrating possible operations of a flow 1000 that may be associated with a collective communication operation, in accordance with an embodiment. In an embodiment, one or more operations of flow 1000 may be performed by data engine 120. At 1002, an amount of data is determined to be sent to a node. At 1004, the amount of data is divided into segments. At 1006, the data is communicated to the node. At 1008, as each segment of data is received at the node, the node broadcasts the data to other nodes without waiting for the full amount of data to be communicated to the node. In an example, the node may broadcast the data to processes on the node itself. More specifically, a node may have processes P0, P1, P2, etc., running on it. Process P0 on the node receives the data from another node and then broadcasts the received data to process P1, P2, etc. The broadcast may be required because those processes may be participating in the allgather operation and the allgather operation requires that all the processes have the final data at the end.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that when executed by at least one processor, cause the at least one processor to identify one or more processes on a node, where the node is part of a first collection of nodes, consolidate data from the one or more processes, communicate the consolidated data to a second node, where the second node is in the first collection of nodes, where the first collection of nodes is part of a first group of nodes, and communicate the consolidated data to a third node, where the third node is in a second collection of nodes, where the second collection of nodes is part of the first group of nodes.

In Example C2, the subject matter of Example C1 can optionally include where the instructions, when executed by the by at least one processor, further cause the at least one processor to communicate the consolidated data to a fourth node, where the fourth node is part of a third collection of nodes, where the third collection of nodes is in a second group of nodes.

In Example C3, the subject matter of any one of Examples C1-C2 can optionally include where the instructions, when executed by the by at least one processor, further cause the at least one processor to receive data related to a gather or a scatter process from the second node.

In Example C4, the subject matter of any one of Examples C1-C3 can optionally include where the received data related to the gather process is combined with the consolidated data before communicating the combined consolidated data to another node, in another collection of nodes, in another group of nodes.

In Example C5, the subject matter of any one of Examples C1-C4 can optionally include where the instructions, when executed by the by at least one processor, further cause the at least one processor to receive data related to the gather process from a fourth node, where the fourth nodes is part of a third collection of nodes, where the third collection of nodes is in a second group of nodes.

In Example C6, the subject matter of any one of Examples C1-05 can optionally include where the instructions, when executed by the by at least one processor, further cause the at least one processor to communicate the data to the second node using a switch, where each node in the first collection of nodes is in communication with the switch.

In Example C7, the subject matter of any one of Examples C1-C6 can optionally include where the consolidated data communicated is to a different group using a pipeline, where the pipeline includes more than one communication path and the consolidated data is divided into portions, where the number of portions is equal to the number of communication paths.

In Example C8 the subject matter of any one of Examples C1-C7 can optionally include where the node is part of an interconnected network.

In Example C9, the subject matter of any one of Examples C1-C8 can optionally include where the node is part of a multi-tiered dragonfly topology network.

In Example S1, a system can include a plurality of a group of nodes, wherein each group of nodes include a plurality of a collection of nodes, wherein each collection of nodes includes a plurality of nodes and at least one processor configured to identify one or more processes on a node, where the node is part of a first collection of nodes, consolidate data from the one or more processes, communicate the consolidated data to a second node, where the second node is in the first collection of nodes, where the collection of nodes is part of a first group of nodes, and communicate the consolidated data to a third node, where the third node is in a second collection of nodes, where the second collection of nodes is part of the first group of nodes.

In Example, S2, the subject matter of Example S1 can optionally include where the at least one process is further configured to receive data from the second node, where the data is related to a gather or a scatter process.

In Example S3, the subject matter of any one of Examples S1-S2 can optionally include where the received consolidated data related to the gather process is combined with the data before communicating the combined consolidated data to another node, in another collection of nodes, in another group of nodes.

In Example S4, the subject matter of any one of Examples S1-S3 can optionally include where the at least one process is further configured to receive data related to the gather process from a fourth node, where the fourth nodes is part of a third collection of nodes, where the third collection of nodes is in a second group of nodes included in the plurality of the first group of nodes.

In Example S5, the subject matter of any one of Examples S1-S4 can optionally include where the at least one process is further configured to communicate the data to the second node using a switch, where each node in the first collection of nodes is in communication with the switch.

In Example S6, the subject matter of any one of Examples S1-55 can optionally include where the consolidated data is communicated to a different group from the plurality of nodes using a pipeline, where the pipeline includes more than one communication path and the consolidated data is divided into portions, where the number of portions is equal to the number of communication paths.

Example A1 is an apparatus for providing a collective communication operation, the apparatus comprising at least one memory element, at least one processor coupled to the at least one memory element, one or more data engines that, when executed by the at least one processor, are configured to identify one or more processes on a node, where the node is part of a first collection of nodes, consolidate data from the one or more processes, communicate the consolidated data to a second node, where the second node is in the collection of nodes, where the collection of nodes is part of a first group of nodes, and communicate the consolidated data to a third node, where the third node is in a second collection of nodes, where the second collection of nodes is part of the first group of nodes.

In Example A2, the subject matter of Example A1 can optionally include where the one or more data engines that, when executed by the at least one processor, are further configured to communicate the consolidated data to a fourth node, where the fourth node is part of a third collection of nodes, where the third collection of nodes is in a second group of nodes.

In Example A3, the subject matter of any one of the Examples A1-A2 can optionally include where the one or more data engines that, when executed by the at least one processor, are further configured to receive data from the second node, where the data is related to a gather process or a scatter process.

In Example A4, the subject matter of any one of the Examples A1-A3 can optionally include where the received data related to the gather process is combined with the consolidated data before communicating the combined consolidated data to another node, in another collection of nodes, in another group of nodes.

In Example A5, the subject matter of any one of the Examples A1-A4 can optionally include where the consolidated data is communicated to a different group using a pipeline, where the pipeline includes more than one communication path and the consolidated data is divided into portions, where the number of portions is equal to the number of communication paths.

Example M1 is a method including identifying one or more collective communication processes on a node, where the node is part of a first collection of nodes, consolidating data from the one or more processes, communicating the consolidated data to a second node, where the second node is in the first collection of nodes, where the first collection of nodes is part of a first group of nodes, and communicating the consolidated data to a third node, where the third node is in a second collection of nodes, where the second collection of nodes is part of the first group of nodes.

In Example M2, the subject matter of Example M1 can optionally include communicating the consolidated data to a fourth node, where the fourth node is part of a third collection of nodes, where the third collection of nodes is in a second group of nodes.

In Example M3, the subject matter of any one of the Examples M1-M2 can optionally include receiving data from the second node, where the data is related to a gather process or a scatter process.

In Example M4, the subject matter of any one of the Examples M1-M3 can optionally include communicating the data to the second node using a switch, where each node in the consolidated collection of nodes is in communication with the switch.

In Example M5, the subject matter of any one of the Examples M1-M4 can optionally include where the consolidated data communicated to a different group using a pipeline, where the pipeline includes more than one communication path and the consolidated data is divided into portions, where the number of portions is equal to the number of communication paths.

Example AA1 is an apparatus including means for consolidating data from one or more processes on a node, wherein the node is part of a first collection of nodes, means for communicating the consolidated data to a second node, wherein the second node is in the first collection of nodes, wherein the first collection of nodes is part of a first group of a collection of nodes, and means for communicating the consolidated data to a third node, wherein the third node is in a second collection of nodes, wherein the second collection of nodes is part of the first group of the collection of nodes.

In Example AA2, the subject matter of Example AA1 can optionally include means for communicating the consolidated data to a fourth node, wherein the fourth node is part of a third collection of nodes, wherein the third collection of nodes is in a second group of a collection of nodes.

In Example AA3, the subject matter of any one of Examples AA1-AA2 can optionally include means for receiving data related to a gather process or a scatter process from the second node.

In Example AA4, the subject matter of any one of Examples AA1-AA3 can optionally include where the received data related to the gather process is combined with the consolidated data before communicating the combined consolidated data to another node, in another collection of nodes, in another group of nodes.

In Example AA5, the subject matter of any one of Examples AA1-AA4 can optionally include means for receiving data related to the gather process from a fourth node, wherein the fourth nodes is part of a third collection of nodes, wherein the third collection of nodes is in a second group of a collection of nodes.

In Example AA6, the subject matter of any one of Examples AA1-AA5 can optionally include means for communicating the consolidated data to the second node using a switch, wherein each node in the first collection of nodes is in communication with the switch.

In Example AA7, the subject matter of any one of Examples AA1-AA6 can optionally include where the consolidated data communicated is to a different group using a pipeline, where the pipeline includes more than one communication path and the consolidated data is divided into portions, where the number of portions is equal to the number of communication paths.

In Example AA8, the subject matter of any one of Examples AA1-AA7 can optionally include where the node is part of an interconnected network.

In Example AA9, the subject matter of any one of Examples AA1-AA8 can optionally include where the node is part of a multi-tiered dragonfly topology network.

Example X1 is a machine-readable storage medium including machine-readable instructions to implement a method or realize an apparatus as in any one of the Examples A1-A5, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable storage medium having instructions stored thereon, wherein the instructions, when executed by at least one processor cause the at least one processor to:
consolidate data from one or more processes on a node, wherein the node is part of a first collection of nodes;
communicate the consolidated data to a second node, wherein the second node is in the first collection of nodes, wherein the first collection of nodes is part of a first group of a collection of nodes; and
communicate the consolidated data to a third node, wherein the third node is in a second collection of nodes, wherein the second collection of nodes is part of the first group of the collection of nodes.

2. The at least one machine readable storage medium of claim 1, wherein the instructions, when executed by the at least one processor further cause the at least one processor to:
communicate the consolidated data to a fourth node, wherein the fourth node is part of a third collection of nodes, wherein the third collection of nodes is in a second group of a collection of nodes.

3. The at least one machine readable storage medium of claim 1, wherein the instructions, when executed by the at least one processor further cause the at least one processor to:
receive data related to a gather process or a scatter process from the second node.

4. The at least one machine readable storage medium of claim 3, wherein the received data is related to the gather process and is combined with the consolidated data before communicating the combined consolidated data to another node, in another collection of nodes, in another group of a collection of nodes.

5. The at least one machine readable storage medium of claim 3, wherein the instructions, when executed by the at least one processor further cause the at least one processor to:
receive data related to the gather process from a fourth node, wherein the fourth nodes is part of a third collection of nodes, wherein the third collection of nodes is in a second group of a collection of nodes.

6. The at least one machine readable storage medium of claim 1, wherein the instructions, when executed by the at least one processor further cause the at least one processor to:
communicate the consolidated data to the second node using a switch, wherein each node in the first collection of nodes is in communication with the switch.

7. The at least one machine readable storage medium of claim 1, wherein the consolidated data is communicated to a different group of a collection of nodes using a pipeline, wherein the pipeline includes more than one communication path and the consolidated data is divided into portions, wherein the number of portions is equal to the number of communication paths.

8. The at least one machine readable storage medium of any one of claim 1, wherein the node is part of an interconnected network.

9. The at least one machine readable storage medium of any one of claim 1, wherein the node is part of a multi-tiered dragonfly topology network.

10. A system comprising:
a plurality of groups, wherein each group includes a plurality of a collection of nodes, wherein each collection of nodes includes a plurality of nodes; and
at least one processor configured to:
consolidate data from one or more processes on a node included in the plurality of nodes, wherein the node is part of a first collection of nodes included in the plurality of the collection of nodes;
communicate the consolidated data to a second node, wherein the second node is in the first collection of nodes, wherein the first collection of nodes is part of a first group included in the plurality of the groups; and
communicate the consolidated data to a third node, wherein the third node is in a second collection of nodes, wherein the second collection of nodes is part of the first group.

11. The system of claim 10, wherein the at least one processor is further configured to:
receive data related to a gather process or a scatter process from the second node.

12. The system of claim 11, wherein the received data is related to the gather process and is combined with the consolidated data before communicating the combined consolidated data to another node, in another collection of nodes, in another group included in the plurality of the groups.

13. The system of claim 11, wherein the at least one processor is further configured to:
receive data related to the gather process from a fourth node, wherein the fourth nodes is part of a third collection of nodes, wherein the third collection of nodes is in a second group included in the plurality of groups.

14. The system of claim 10, wherein the at least one process is further configured to:
communicate the consolidated data to the second node using a switch, wherein each node in the first collection of nodes is in communication with the switch.

15. The system of claim 10, wherein the consolidated data is communicated to a different group from the plurality of nodes using a pipeline, wherein the pipeline includes more than one communication path and the consolidated data is divided into portions, wherein the number of portions is equal to the number of communication paths.

16. An apparatus for providing a collective communication operation, the apparatus comprising:
at least one memory element;
at least one processor coupled to the at least one memory element;
one or more data engines that, when executed by the at least one processor, are configured to:
consolidate data from one or more processes on a node, wherein the consolidated data is related to a collective communication operation, wherein the node is part of a first collection of nodes;
communicate the consolidated data to a second node, wherein the second node is in the first collection of nodes, wherein the collection of nodes is part of a first group of a collection of nodes; and
communicate the consolidated data to a third node, wherein the third node is in a second collection of nodes, wherein the second collection of nodes is part of the first group of the collection of nodes.

17. The apparatus of claim 16, wherein the one or more data engines that, when executed by the at least one processor, are further configured to:
communicate the consolidated data to a fourth node, wherein the fourth node is part of a third collection of nodes, wherein the third collection of nodes is in a second group of a collection of nodes.

18. The apparatus of claim 17, wherein the one or more data engines that, when executed by the at least one processor, are further configured to:
receive data related to a gather process or a scatter process from the second node.

19. The apparatus of claim 18, wherein the received data is related to the gather process and is combined with the consolidated data before communicating the combined consolidated data to another node, in another collection of nodes, in another group of a collection of nodes.

20. The apparatus of claim 16, wherein the consolidated data is communicated to a different group of a collection of nodes using a pipeline, wherein the pipeline includes more than one communication path and the consolidated data is divided into portions, wherein the number of portions is equal to the number of communication paths.

21. A method comprising:
identifying one or more collective communication processes on a node, wherein the node is part of a first collection of nodes;
consolidating data from the one or more processes;
communicating the consolidated data to a second node, wherein the second node is in the first collection of nodes, wherein the collection of nodes is part of a first group of a collection of nodes; and
communicating the consolidated data to a third node, wherein the third node is in a second collection of nodes, wherein the second collection of nodes is part of the first group of the collection of nodes.

22. The method of claim 21, further comprising:
communicating the consolidated data to a fourth node, wherein the fourth node is part of a third collection of nodes, wherein the third collection of nodes is in a second group of a collection of nodes.

23. The method of claim 21, further comprising:
receiving data related to a gather process or a scatter process from the second node.

24. The method of claim 21, further comprising:
communicating the data to the second node using a switch, wherein each node in the first collection of nodes is in communication with the switch.

25. The method of claim 21, wherein the consolidated data is communicated to a different group of a collection of nodes using a pipeline, wherein the pipeline includes more than one communication path and the consolidated data is divided into portions, wherein the number of portions is equal to the number of communication paths.
